(19) United States
(12) Patent Application Publication
(10) Pub. No.: US 2025/0321429 A1
(43) Pub. Date: Oct. 16, 2025

(54) SUPPORTING FRAME AND HEAD-MOUNTED DISPLAY DEVICE

(71) Applicant: HTC Corporation, Taoyuan City (TW)

(72) Inventor: Meng Yu Jian, Taoyuan City (TW)

(73) Assignee: HTC Corporation, Taoyuan City (TW)

(21) Appl. No.: 18/635,004

(22) Filed: Apr. 15, 2024

(51) Int. Cl. G02B 27/01

(52) U.S. Cl. CPC G02B 27/0176; G02B 27/0172

(57) ABSTRACT

A supporting frame and a head-mounted display device are provided. The head-mounted display device includes a display portion and the supporting frame. The supporting frame includes a fixing portion, a platform portion, two cantilever arms, and two fitting pads. The fixing portion is configured to be assembled to the display portion. The platform portion is fixed to the fixing portion and configured to lean against a top of the display portion. A first end of each of the cantilever arms is fixed to the fixing portion. Each of the fitting pads is pivotally connected to a second end of the corresponding cantilever arm.

### BACKGROUND

### Technical Field

The disclosure relates to a supporting frame and a display device, and more particularly, to a supporting frame and a head-mounted display device.

### Description of Related Art

In recent years, the application of virtual reality (VR) has become more and more popular, and there are many types of head-mounted display devices. However, in existing head-mounted display devices, the components used to contact the face are not suitable for all users, causing some users to feel uncomfortable when wearing such head-mounted display devices. Therefore, how to make the head-mounted display device more securely worn on the head of the user while also providing the user with a more comfortable experience is an extremely important issue in the art.

### SUMMARY

The disclosure provides a supporting frame and a head-mounted display device, which helps to improve comfortability for a user when wearing the head-mounted display device.

A supporting frame in the disclosure is configured to be assembled to a head-mounted display device. The supporting frame includes a fixing portion, two cantilever arms, and two fitting pads. The fixing portion is configured to be assembled to the head-mounted display device. The platform portion is fixed to the fixing portion and configured to lean against a top of the head-mounted display device. A first end of each of the cantilever arms is fixed to the fixing portion. Each of the fitting pads is pivotally connected to a second end of the corresponding cantilever arm.

A head-mounted display device in the disclosure includes a display portion and a supporting frame. The supporting frame includes a fixing portion, two cantilever arms, and two fitting pads. The fixing portion is configured to be assembled to the display portion. The platform portion is fixed to the fixing portion and configured to lean against a top of the display portion. A first end of each of the cantilever arms is fixed to the fixing portion. Each of the fitting pads is pivotally connected to a second end of the corresponding cantilever arm.

Based on the above, in the supporting frame and the head-mounted display device in the disclosure, the fitting pads may rotate to match shapes of the heads of different users, which helps to improve comfortability and stability.

### BRIEF DESCRIPTION OF THE DRAWINGS

FIG. 1 is a schematic view of a head outline of various users.

FIG. 2A is a schematic view of a usage state of a head-mounted display device according to an embodiment of the invention.

FIG. 2B is a schematic side view of the head-mounted display device in FIG. 2A.

FIGS. 3A to 3D are schematic views of states in which a supporting frame of the head-mounted display device in FIG. 2A is matched with heads of four different users.

FIG. 4 is a schematic view of a head-mounted display device according to another embodiment of the invention.

FIG. 5A is a schematic view of a disassembled state of a supporting frame according to another embodiment of the invention.

FIG. 5B is a schematic view of an assembled state of the supporting frame in FIG. 5A.

FIG. 6 is a schematic view of a head-mounted display device according to still another embodiment of the invention.

### DETAILED DESCRIPTION OF DISCLOSED EMBODIMENTS

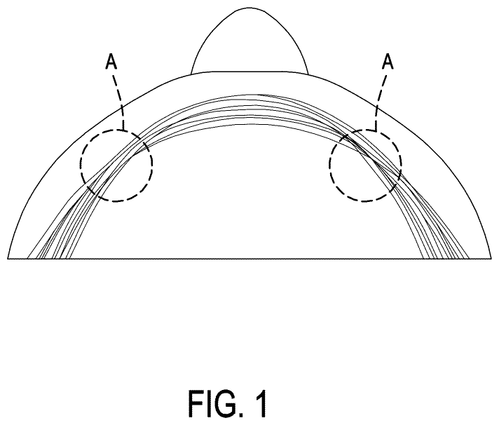

FIG. 1 is a schematic view of a head outline of various users. FIG. 1 shows contour lines of heads of various users at forehead positions. According to FIG. 1, although the contour lines of the heads of different users are different to varying degrees, it is still possible to find positions where the contour lines almost pass through on both sides of a forehead, such as circled points A in the figure.

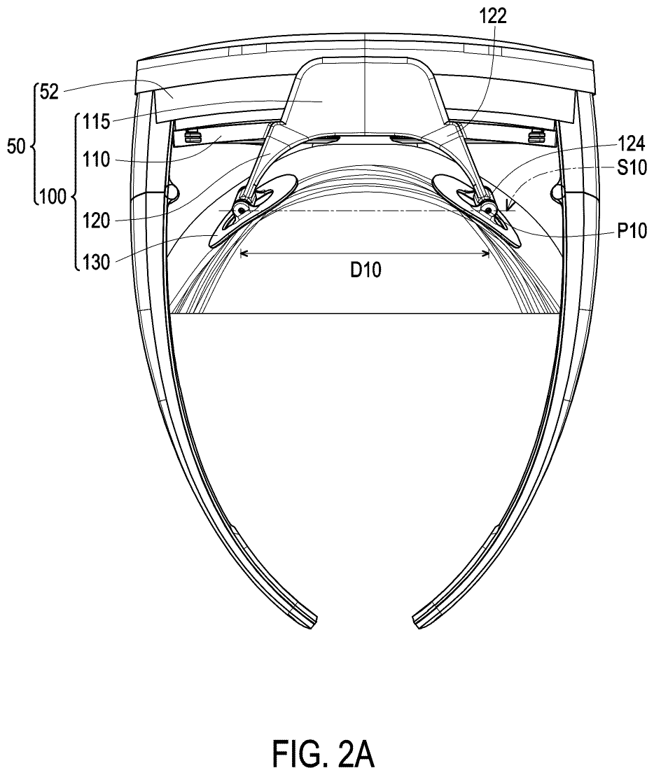

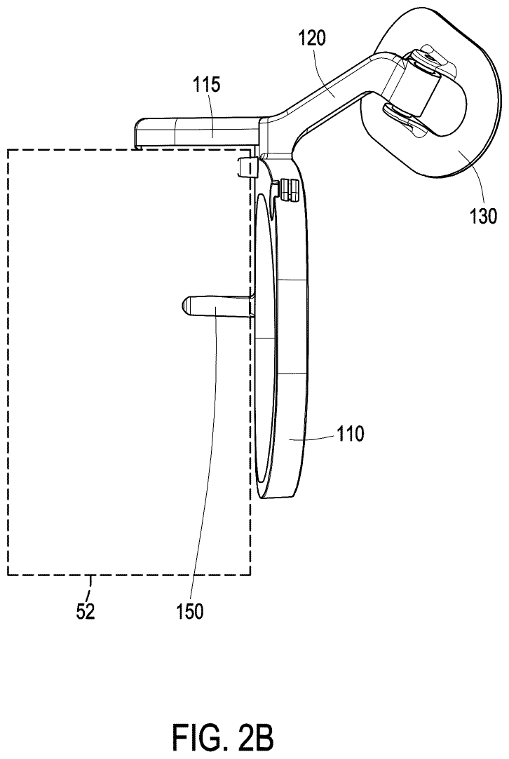

FIG. 2A is a schematic view of a usage state of a head-mounted display device according to an embodiment of the invention. Referring to FIG. 2A, a head-mounted display device 50 in this embodiment includes a display portion 52 and a supporting frame 100. The supporting frame 100 in this embodiment includes a fixing portion 110, a platform portion 115, two cantilever arms 120, and two fitting pads 130. The fixing portion 110 is configured to be assembled to the display portion 52 of the head-mounted display device 50. The platform portion 115 leans against a top of the display portion 52 of the head-mounted display device 50. A first end 122 of each of the cantilever arms 120 is fixed to the fixing portion 110. Each of the fitting pads 130 is pivotally connected to a second end 124 of the corresponding cantilever arm 120.

In the head-mounted display device 50 in this embodiment, positions of two pivot points P10 correspond exactly to the circled points A in FIG. 1, which is a place where the contour lines of the heads of most users pass through. In addition, since the fitting pad 130 for fitting the forehead of the user is pivotally connected to the cantilever arm 120, the fitting pad 130 may rotate according to the head outlines of different users, and may better contact the head of the user, which helps to improve comfortability for the user when wearing the head-mounted display device, thereby increasing stability thereof when worn on the head of the user.

FIG. 2B is a schematic side view of the head-mounted display device in FIG. 2A. The display portion 52 is only represented by a dashed frame. Referring to FIGS. 2A and 2B, since the platform portion 115 leans against the top of the display portion 52, it may also prevent the supporting frame 100 from flipping relative to the display portion 52 of the head-mounted display device 50, further increasing the stability thereof when worn on the head of the user. In addition, the supporting frame 100 in this embodiment may include a fixing pin 150 configured to be inserted into the display portion 52 of the head-mounted display device 50, which may further increase the stability of the entire device.

In this embodiment, a distance between the two fitting pads 130 and the two pivot points P10 of the two cantilever arms 120 is between 6 cm and 11 cm. A distance D10 between the two pivot points P10 is between 6 cm and 11 cm.

In this embodiment, when the head-mounted display device 50 is worn on the head of the user, the two pivot points P10 are located on a vertical plane S10 where eyes of the user are located. In other words, the two pivot points P10 are on the same plane as the eyes of the user, and this plane is a vertical plane, that is, the vertical plane S10.

In other embodiments of the disclosure, when the head-mounted display device 50 is worn on the head of the user, a distance between the pivot points P10 and the vertical plane S10 where the eyes of the user are located is between −1.1 cm and 1.1 cm. In other words, the two pivot points P10 may be in front of or behind the vertical plane S10, and the distance from the vertical plane S10 is between −1.1 cm and 1.1 cm.

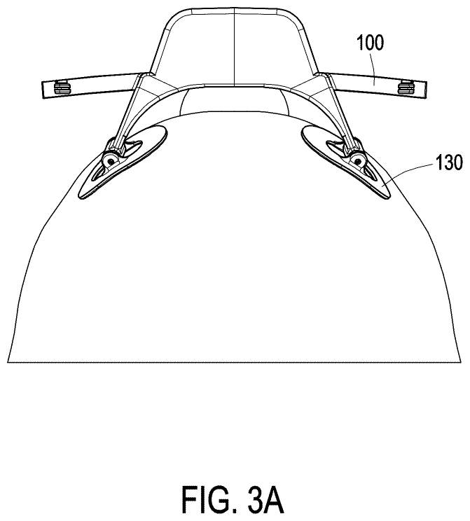

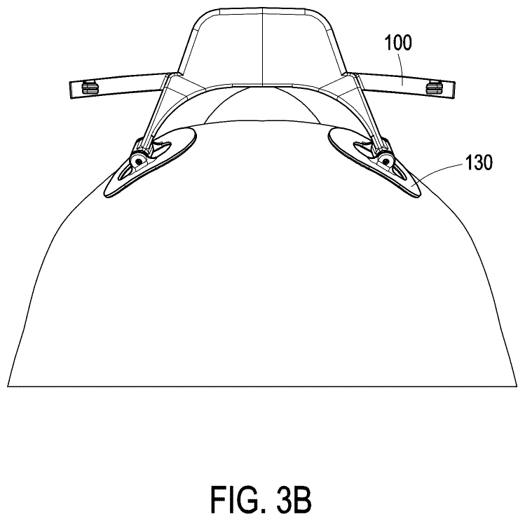

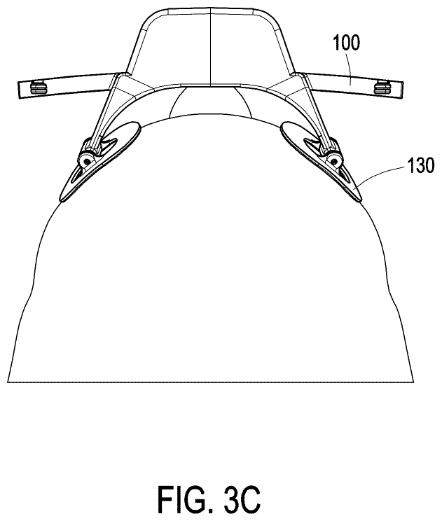

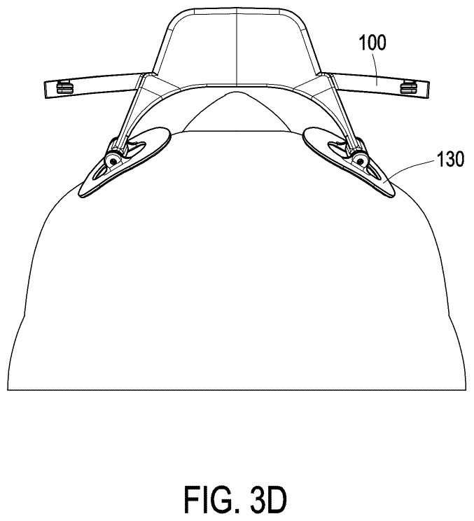

FIGS. 3A to 3D are schematic views of states in which a supporting frame of the head-mounted display device in FIG. 2A is matched with heads of four different users. Referring to FIGS. 3A to 3D, although shapes of the heads of the users in the figures are different, since the fitting pad 130 may rotate, it may better contact the head of the user, which helps to improve the comfortability for the user when wearing the head-mounted display device, thereby increasing the stability thereof when worn on the head of the user.

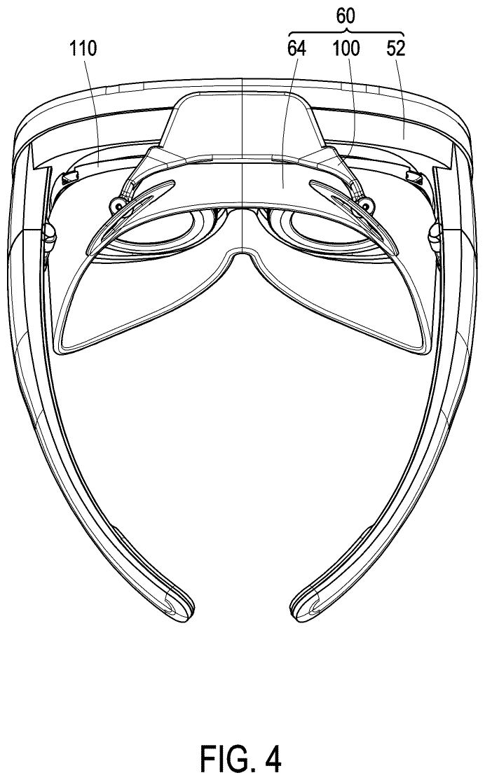

FIG. 4 is a schematic view of a head-mounted display device according to another embodiment of the invention. Referring to FIG. 4, in another embodiment of the disclosure, a head-mounted display device 60 further includes a light shield 64 assembled to the fixing portion 110 of the supporting frame 100. The light shield 64 is configured to surround space between the display portion 52 of the head-mounted display device 60 and the eyes of the user to reduce an influence of external light and enhance an immersive feeling when viewing images. The light shield 64 is flexible to cover the eyes of the user. In this embodiment, a material of the light shield 64 is, for example, a sponge, a foam material, or other flexible materials, but the disclosure is not limited thereto. In addition to providing a light-shielding effect, the flexible light shield 64 also provides an effect of supporting the display portion 52 of the head-mounted display device 60. Specifically, an upper side of the light shield 64 may abut against an upper side of the eyes of the user, such as a frontal bone of the user. A lower side of the light shield 64 may abut against a lower side of the eyes of the user, such as a cheekbone of the user. In more detail, since the lower side of the light shield 64 may abut against the lower side of the eyes of the user, the pressure exerted by the head-mounted display device 60 on a nose of the user may be reduced, thereby improving the wearing comfortability for the user. Two opposite sides of the light shield 64 may abut against two opposite sides of the eyes of the user, such as ends of the eyes of the user.

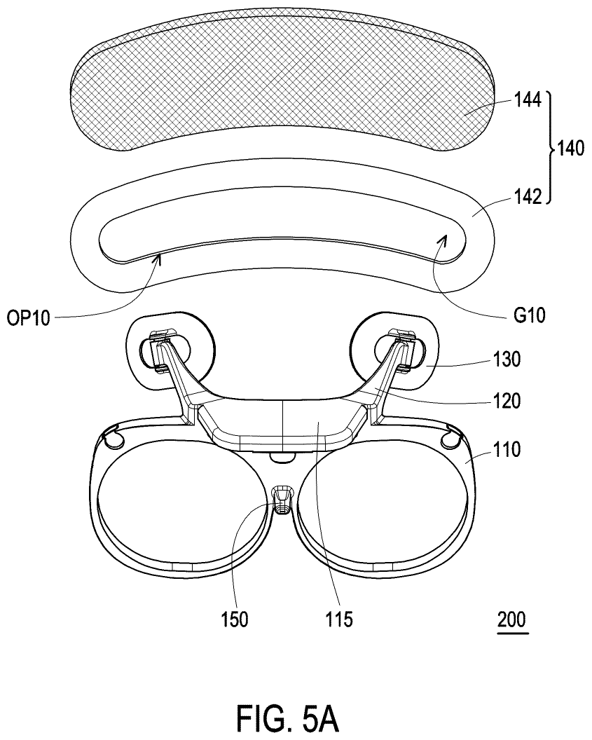

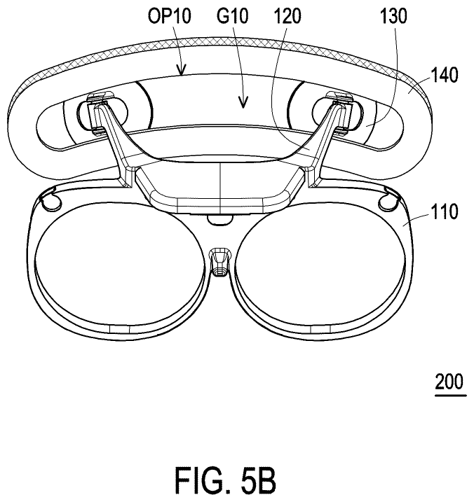

FIG. 5A is a schematic view of a disassembled state of a supporting frame according to another embodiment of the invention. FIG. 5B is a schematic view of an assembled state of the supporting frame in FIG. 5A. Referring to FIGS. 5A and 5B, a supporting frame 200 according to another embodiment of the disclosure further includes a soft pad 140 configured to contact the head of the user. There is a sliding groove G10 in the soft pad 140. The fitting pad 130 of the supporting frame 200 is detachably slidable in the sliding groove G10. The fitting pad 130 and the cantilever arm 120 are pivotally connected to each other through an opening OP10 of the sliding groove G10. Since the soft pad 140 is flexible, it may deform according to the shape of the head of the user and provide a comfortable contact feeling. During a deformation process of the soft pad 140, the fitting pad 130 may slide in the sliding groove G10, so the deformation of the soft pad 140 will not be restricted. In addition, the fitting pad 130 may also be taken out from the sliding groove G10, so the user may clean the soft pad 140 to maintain hygiene. For example, the soft pad 140 may include a fixing pad 142 and a contact pad 144. The fixing pad 142 has the sliding groove G10, and the contact pad 144 is attached to a side of the fixing pad 142 that does not have the opening OP10.

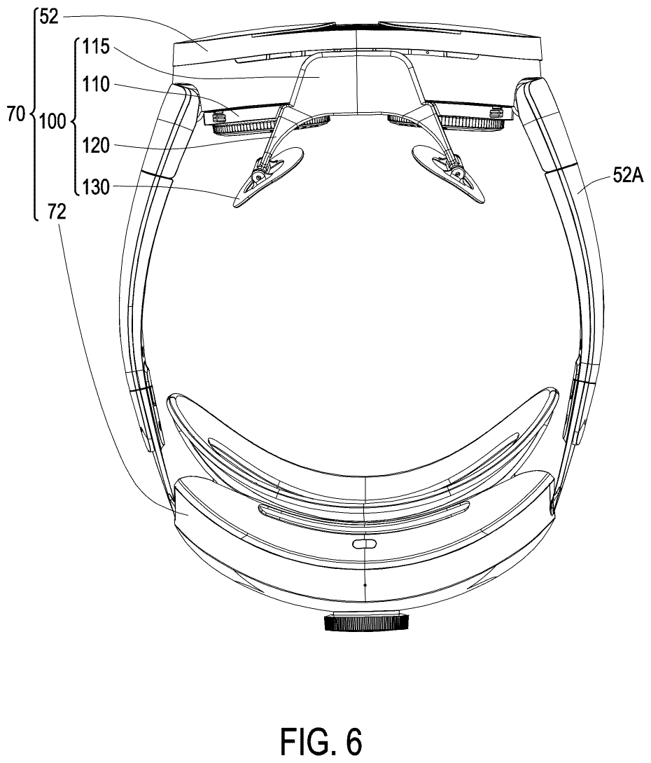

FIG. 6 is a schematic view of a head-mounted display device according to still another embodiment of the invention. Referring to FIG. 6, a head-mounted display device 70 in this embodiment is generally similar to the head-mounted display device 50 in FIG. 2A, and only differences will be described here. The head-mounted display device 70 in this embodiment further includes a head band module 72, and two opposite sides thereof are detachably assembled to the display portion 52 respectively. When the display portion 52 and the head band module 72 are assembled together, even if the user makes violent movements, the head-mounted display device 70 may still be securely fixed on the head of the user without worrying about falling or even being damaged.

In this embodiment, a distance between the two opposite sides of the head band module 72 is adjustable. That is, after the display portion 52 and the head band module 72 are assembled, the users with different head sizes may comfortably and securely wear the head-mounted display device 70 on their heads by adjusting the distance between the two opposite sides of the head band module 72.

In this embodiment, the head band module 72 is two holders 52A detachably connected to the display portion 52. In another usage scenario, the head band module 72 may be removed. For example, when the user watches a video or engages in other static activities, since no strong fixing force is required, the user may enjoy a lighter use experience by removing the headband module 72. In other embodiments, the holder 52A may also be connected to other expanded functional components, so the head-mounted display device 70 has greater convenience in use.

Based on the above, in the supporting frame and the head-mounted display device in the disclosure, since the supporting frame contacts the head of the user with the two rotatable fitting pads, it may be rotated to suit the head shape of different users, which helps to improve the comfortability for the user when wearing the head-mounted display device, thereby increasing the stability thereof when worn on the head of the user. In addition, the platform portion leans against the top of the display portion, which may also prevent the supporting frame from flipping relative to the display portion of the head-mounted display device, further increasing the stability thereof when worn on the head of the user.

What is claimed is:

1. A supporting frame configured to be assembled to a head-mounted display device, wherein the supporting frame comprises:
a fixing portion configured to be assembled to the head-mounted display device;
a platform portion fixed to the fixing portion and configured to lean against a top of the head-mounted display device;
two cantilever arms, wherein a first end of each of the cantilever arms is fixed to the fixing portion; and
two fitting pads, wherein each of the fitting pads is pivotally connected to a second end of the corresponding cantilever arm.

2. The supporting frame according to claim 1, wherein when the supporting frame is worn on a head of a user, pivot points are located on a vertical plane where eyes of the user are located.

3. The supporting frame according to claim 1, wherein when the supporting frame is worn on a head of a user, a distance between pivot points and a vertical plane where eyes of the user are located is between −1.1 cm and 1.1 cm.

4. The supporting frame according to claim 1, further comprising a soft pad configured to contact a head of a user, wherein there is a sliding groove in the soft pad, the fitting pads are detachably slid in the sliding groove, and the fitting pads and the cantilever arms are pivotally connected to each other through an opening of the sliding groove.

5. The supporting frame according to claim 1, wherein a distance between the fitting pads and two pivot points of the cantilever arms is between 6 cm and 11 cm.

6. A head-mounted display device, comprising:
a display portion;
a supporting frame, comprising:
a fixing portion configured to be assembled to the display portion;
a platform portion fixed to the fixing portion and configured to lean against a top of the display portion;
two cantilever arms, wherein a first end of each of the cantilever arms is fixed to the fixing portion; and
two fitting pads, wherein each of the fitting pads is pivotally connected to a second end of the corresponding cantilever arm.

7. The head-mounted display device according to claim 6, wherein when the head-mounted display device is worn on a head of a user, pivot points are located on a vertical plane where eyes of the user are located.

8. The head-mounted display device according to claim 6, wherein when the head-mounted display device is worn on a head of a user, a distance between pivot points and a vertical plane where eyes of the user are located is between −1.1 cm and 1.1 cm.

9. The head-mounted display device according to claim 6, wherein the supporting frame further comprises a soft pad configured to contact a head of a user, there is a sliding groove in the soft pad, the fitting pads are detachably slid in the sliding groove, and the fitting pads and the cantilever arms are pivotally connected to each other through an opening of the sliding groove.

10. The head-mounted display device according to claim 6, further comprising a light shield assembled to the fixing portion, wherein the light shield is configured to surround space between the display portion and eyes of a user.

11. The head-mounted display device according to claim 6, wherein a distance between the fitting pads and two pivot points of the cantilever arms is between 6 cm and 11 cm.

12. The head-mounted display device according to claim 6, further comprising a head band module, wherein two opposite sides thereof are detachably assembled to the display portion.
